(19) United States
(12) Patent Application Publication
(10) Pub. No.: US 2004/0243704 A1
(43) Pub. Date: Dec. 2, 2004

(54) System and method for determining the unique web users and calculating the reach, frequency and effective reach of user web access

(76) Inventors: Alfredo Botelho, Burlingame, CA (US); Roy S. de Souza, San Francisco, CA (US)

Correspondence Address: THOMAS A. WARD, FLIESLER MEYER LLP, Fourth Floor, Four Embarcadero Center, San Francisco, CA, 94111-4156, US

(21) Appl. No.: 10/823,393

(22) Filed: Apr. 13, 2004

Related U.S. Application Data
(60) Provisional application No. 60/462,662, filed on Apr. 14, 2003.

(51) Int. Cl. G06F 15/173; G06F 17/60

(52) U.S. Cl. 709/224; 705/14

(57) ABSTRACT

A system and method provide for measuring the effectiveness of online advertising using reach, frequency and effective reach. The system is able to count a user access, even it is served from a cache. The system is further able to distinguish between a unique user accessing a web site for the first time, and users making repeated accesses. The system further does not require a calculation using data commonly stored in a large data access file log of a server to count users, and preserves user privacy while maintaining a count.

### PRIORITY CLAIM TO PROVISIONAL APPLICATION

This patent application claims priority to U.S. Provisional Patent Application No. 60/462,662, entitled “System and Method for Determining the Unique Web Users and Calculating the Reach, Frequency and Effective Reach of the Web Access,” filed Apr. 14, 2003.

### BACKGROUND

1. Technical Field

The present invention relates to the World Wide Web (hereafter referred to as web) and, in particular to the field of web-based advertisement. More particularly, the present invention relates to identifying when web users access content on the web to determine the frequency of access to particular web content, such as advertisements, as well as the reach and effective reach of user access of related content.

2. Related Art

The web is typically accessed using the HTTP protocol. Web content is formatted in HTML or XML. A page is a collection of objects (HTML formatted inline text with embedded objects such as applets and images). HTTP protocol allows the user agent, usually a browser to issue a fetch of the object using its URL. For example it may issue a request to fetch the URL http://www.foo.com/index.html. Here www.foo.com denotes the site where the content is stored, and index.html is the HTML formatted file to be fetched. The browser then interprets the fetched file. During the interpretation additional fetch operations are done for the embedded objects. Once a page and all its embedded objects are fetched, a page is completely loaded and is visible fully to the end user.

In a typical fetch of the page, it might have made a number of fetches (usually referred as the GET operation in HTTP) from the same site or from a set of sites where the content is distributed. In general, the HTTP operation involves a Request operation that results in a Response. A request is characterized by a URL, a request method, a set of HTTP headers, and some optional data. A response is characterized by a response code, a set of response headers and optional data.

HTTP protocol is a stateless protocol. Between two fetches, nothing is remembered. However, a cookie specification allows the server to attach a special header called a cookie. Cookies are sent back to the server in the subsequent requests providing a way to maintain state across HTTP requests.

Many web sites include advertisement objects along with their web page content. The advertisements can be stored locally or distributed over the Internet. The major metrics used for measuring advertising exposure is hits, clicks, page views/impressions, unique visitors, repeat unique visitors and total visits. In these metrics, unique users and repeat unique users are the most widely used. The distribution of these measurements over different demographic data, different time frames and other target segments are needed for evaluating the performance of the advertisement and understanding the web user trends and hence enable better targeting.

### SUMMARY

In accordance with the present invention, a system and method are providing for measuring the effectiveness of online advertising using reach, frequency and effective reach. The system is able to count a user access, even if it is served from a cache. The system is further able to distinguish between a unique user accessing a web site for the first time, and users making repeated accesses. The system further does not require a calculation using data commonly stored in a large data access file log of a server to count users, and preserves user privacy while maintaining a count.

To minimize the load on a server, counting is performed using a counter cookie. A cookie is a (name, value) pair with a set of properties—such as path, domain name and expiration time. As one example, the counter cookie stores an object ‘o’ along with an indication of its count of accesses “k”, or count(o, k). An object can have more than one counter cookie depending on the type of the event log required for the object. For example, if an event has to be accounted on yearly and monthly basis then two counter cookies are used.

Counter cookies are written to the access log after a count, along with other normally stored access log parameters. The counter cookies can be written using either client size script or server side script. If there are ‘n’ entries in the log file, count(o, k) requires only ‘n’ number of comparisons to determine frequency and assure a repeat user is not counted twice, while previous systems required nlog(n) computations.

A web beacon is used to assure a count occurs even if an object is retrieved from cache. The web beacon is a 1 by 1 pixel transparent image inside a page served. The web beacon allows a user count even if an object is fetched from cache, the web beacon being specified as not cacheable so that it is retrieved from the origin server every time a request is made and represents the original page.

### BRIEF DESCRIPTION OF THE DRAWINGS

Further details of the present invention are explained with the help of the attached drawings in which:

FIG. 1 shows a simplified network diagram for components making up the preferred system in accordance with the present invention;

FIGS. 2A-2D are data flow diagrams showing communication between the components of FIG. 1;

FIG. 3 shows a flow diagram for the components of FIG. 1 for counting unique visitors using client side script for calculating the cookie and a web beacon for overriding the caching;

FIG. 4 shows a flow diagram for counting unique visitors using server side script for calculating the cookies and a web beacon for overriding the caching;

FIG. 5 shows a flow diagram for counting unique visitors using client side script for non-cacheable pages;

FIG. 6 shows a flow diagram for counting unique visitors using server side script for non-cacheable pages; and

FIGS. 7-9 provide data charts showing frequency vs. effective reach taken using a model for the preferred system.

### DETAILED DESCRIPTION

1. Terminology

In accordance with the present invention a method is described for measuring the effectiveness of online advertising using reach, frequency and effective reach. The number of unique users that access an advertisement at least once over a period of time is called the reach of the advertisement over that period of time. The average number of times a unique user accesses an advertisement over a period of time is the frequency of the exposure of the advertisement over that period of time. The effective reach is the percentage of users reached at a particular frequency or higher. These measurements are further extended to different target segments.

The reach of an advertisement is calculated by logging the user accesses and counting the unique users from the access log using the unique identity assigned to the user. Some systems use IP address of the HTTP request source in the access log to count the unique users.

The access log (W3C format) contains the accessed URL, source IP address, time of access, request headers including cookies. Analyzing the log for unique users involves sorting the records in the order of the cookies or IP address and eliminating the duplicates.

2. Problems Addressed

The problems occurring when calculating reach and frequency of web objects include the following:

a. Content Served from Caches

The system must be able to count a user access even if it is served from a cache. There are browser cache, proxy server cache and Content Delivery Networks (CDNs).

b. Counting Unique Visitors

The system must be capable of distinguishing between a unique user accessing the web site for the first time and the repeated accesses.

c. Limited Server Load

The system should not increase the load on the web server significantly.

d. Data Extraction from Access Log File of Servers.

The access log file of a web server is normally very big. The system should provide a less expensive and speedy solution for counting.

e. Privacy Preservation

The privacy of the user needs to be preserved.

3. Previous Systems

Previous systems for measuring the web page exposure typically include two parts: (a) identifying the unique user; and (b) analyzing the web server's access log. Details of these two parts are described in the paragraphs to follow.

a. User Identification

i. Tracking Visitors Using a Unique ID and Password

With this type user identification implemented, every user uses a unique ID and password before entering a web site. This method is useful for contents served from a single web site. But advertisements are normally spread over many sites and it is not practical to implement user ID and password access for all the sites. This method fails to account the content served from the caches. Also, it is not able to separate out the repeated access by the same visitor that has already provided an ID. This method further provides a disadvantage since users can be tracked by this unique ID, which will breach the privacy of the user.

ii. Tracking Visitors Using the IP Address for the Visitor

Many users use dynamic IP addressing of the Internet Service Provider. In some cases the request is made from the proxy server. In this case, the IP address of the visitor as seen at the server side will be the IP address of this proxy server. This method, however, fails to account for requests made to the caches.

iii. Identifying Visitors Using Cookies

Persistent cookies can be used for identifying a visitor. A cookie is a text only string stored in the memory of the browser or saved in a text file at browser side and holds a web site's state variables. The cookie string contains a domain name of the web site it belongs to, path of the URL, and value. Cookies can be set by the web server or by using client side scripts.

iv. Other Methods of Visitor Identification

Some methods use a combination of the above three methods i, ii and iii to identify visitors.

Some systems use a web beacon, or a 1 by 1 pixel transparent image inside a page served. The web beacon can solve the caching problem, where access to cached advertisements are not identified. This web beacon is specified as not cacheable so that it is retrieved from the origin server every time a request is made and represents the original page request.

b. Counting from an Access Log

An access log is typically hosted at either the publisher site or remotely at a third party site. Expensive computation is typically used to count the unique users. An even more expensive computation is typically used to calculate frequency of access and effective reach.

The count of unique users involves a counting process and comparison checks with previous entries to assure that a user is not counted twice. During a typical count of users in an access log file, repeated accesses get logged in the same log file. To count only unique users, at each step of the counting process, comparisons with the previous entries are needed to make sure that this user is not counted already. When checking the i^{th} entry, (i−1) comparisons are to be made with the previous entries. The maximum number of comparisons needed at each step follows the sequence 0, 1, 2, 3, 4, . . . , n−1 where ‘n’ is the total number of entries in the log file. The total number of comparisons is the sum of comparisons at each step and this yields a function of O(nlog(n)) comparisons.

Calculating the frequency of access takes more computations than for calculating the unique user count. Convention systems typically do not provide an easy solution for calculating the frequency and effective reach.

4. Overview of System According to Present Invention

In accordance with the present invention, a preferred system and method are provided for determining the reach, frequency and absolute reach of an object. The distribution of the data with respect to demographic and different time frames is also provided.

The preferred system is explained using an object and event model. The preferred system is described to include two sets <N, V> where N is an expanding set of users and V is a set of web page views. A hit is defined as the request made to the server for fetching an object. Web page view is defined as a hit for the web page.

To define the system, initially let the web page view ‘Vi’ include a set of objects {o1, o2, o3, o4 . . . , on}, including an advertisement object. Further, let the number of unique users to a web page over a period of time ‘t’ be ‘Uₜ’. Let the number of unique users who are visiting the web page for i^{th} time over a time period ‘t’ be ‘Uᵢₜ’.

An event is identified as e=<n, o> where a unique user ‘n’ access a unique object ‘o’. Let E=[e₁, e₂, . . . ] be the list of events happening over a period of time ‘t’. Let index(eᵢ) be a selector function returning the associated object index of the event eᵢ. Eg: if eᵢ=<n1, o4> then index(eᵢ)=4. Let seq(eᵢ) give the frequency of eᵢ in E. Let eq(x, y) be a function which returns ‘1’ if x and y are equal. eq(x, y)=1 if x=y. eq(x, y)=0 if x≠y. A function count(o, k) is then defined as the count of all the events eᵢ=<nᵢ, o> where eᵢεE and seq(eᵢ)=k. This gives U_{kT}=count(o, k). The function count(o, k) is then calculated using:

$$count ( {o}_{i} , k ) = {\sum }_{j = 0}^{n} seq ( index ( {e}_{j} ) , i ) \vert {e}_{j} ϵ E and seq ( {e}_{j} ) = k .$$

The reach of an advertisement is the number of unique users over a period of time. The reach of an advertisement over a time period t=count(o,1), where ‘o’ is the advertisement object. The effective reach of an advertisement object ‘o’ is the count(o, k) where k=1, 2, 3, . . .

The preferred system uses read and write capability of cookies for uniquely identifying the frequency of events. The term ‘counter cookie’ is used to represent this. The counter cookie is written to the access log along with other access log parameters.

A cookie is a (name, value) pair with a set of properties—path, domain name and expiry time. Using the same counter cookie for objects from a domain can save the cookie storage space. One method the preferred system uses is to represent the value of the counter cookie as a (name, value) pair of counter cookies of the domain with a delimiter.

The same object can have more than one counter cookie depending on the type of the event log required for the object. For example, if an event has to be accounted on yearly and monthly basis then two counter cookies are used. For getting the results on various target segments, the target information also needs to be logged into one or more access logs. This can be achieved in two ways, one is to log the information directly into the access logs and the other is to use different access logs for different categories. The second method is preferred since it needs a lower number of computations for calculating the reach.

To establish a cookie count, let C={c₁, c₂, c₃, . . . , cₙ} be the set of counter cookies for a system. Let val(c, n)=the current value of a counter cookie ‘c’ for the user ‘n’. When an event eᵢ=<nᵢ, oᵢ> occurs, the value of the counter cookie is:

val(cᵢ, nᵢ)=1 if val(cᵢ, nᵢ) is not defined; and

val(cᵢ, nᵢ)=val(cᵢ, nᵢ)+1 if val(cᵢ, nᵢ) is defined

where all cᵢεC and belongs to object oᵢ.

This event is logged with the value of the counter cookie and the object identifier (normally the URL of the object). When an event repeats, the counter cookie value corresponding to this event is incremented. Incrementing the counter cookie can be done using the client side script or server side program. The counter value for count(o, k) over a period of time is obtained by counting the entries in the log file, where the value of the counter cookie equals ‘k’ and the unique identifier equals the unique object identifier of the object ‘o’. If there are ‘n’ entries in the log file, count(o, k) requires only ‘n’ number of comparisons. Thus the preferred system requires only O(n) computations and is very efficient compared to the O(nlog(n)) comparisons of prior methods described previously.

The preferred system uses web beacons for objects that are cacheable, enabling objects retrieved from cache to be counted as described above. These web beacons can be used for billing the advertisements served and targeting the users for future advertisements. In addition, web beacons are used for event forecasting by the advertisement allocation systems.

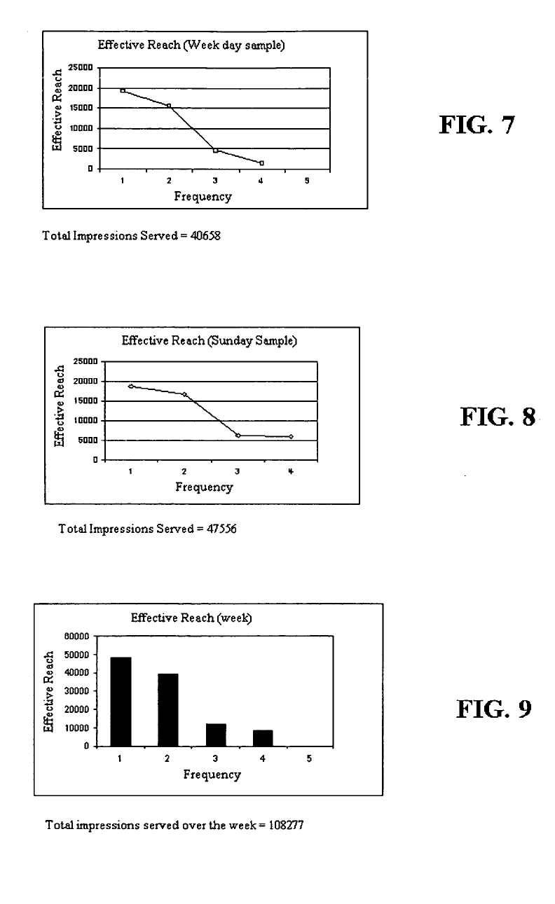

A sample frequency vs. effective reach graph is shown in FIGS. 7-9, discussed subsequently. The data in FIGS. 7-9 is pulled from a model that implements the preferred system described herein. Looking at the chart it is easy to understand how effective the ad is on different days of the week. The chart shows the variation over a weekend and weekday.

5. Glossary of Symbols

Provided below for reference is a glossary of symbols used in the equations described above.

1. < >—Tuple of variables.

eg: <a,b>—tuple of variables ‘a’ and ‘b’.

2. ε—belongs to

eg: aεB denotes ‘a’ belongs to ‘B’.

3. { }—set of elements

eg: {a, b, c}—‘a’, ‘b’ and ‘c’ are the members of the set.

4. [ ]—list of elements

[a, b, c]—a list of elements ‘a’, ‘b’ and ‘c’.

5. Σ—summation

$$eg \text{:} {\sum }_{j = 0}^{n} f ( j ) = f ( 0 ) + f ( 1 ) + … + f ( n ) .$$

6. |—given that

This means do the operations on the left side of ‘|’ if the expressions on the right hand sides are ‘true’.

7. O( )—order of

eg: O(n)—to the order of n.

7. System Components and Operation

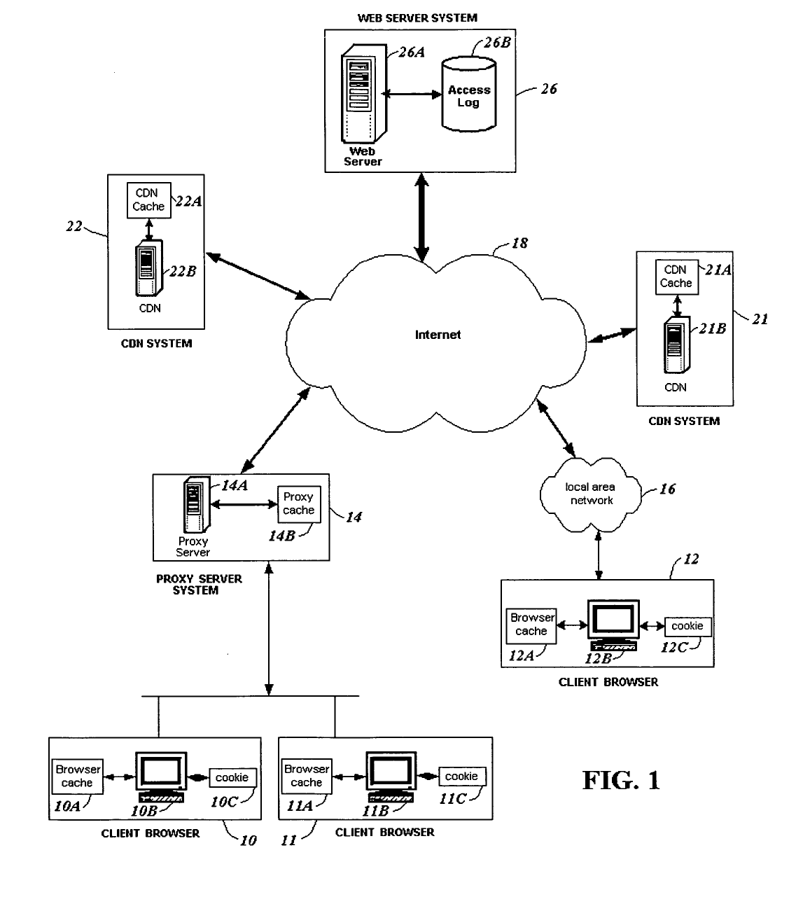

FIG. 1 shows a simplified network diagram for components making up the preferred system in accordance with an embodiment of the present invention. FIG. 1 includes client browsers 10, 11 and 12 shown trying to access a web site on web server system 26. Client browsers 10 and 11 are connected to the Internet 18 through a proxy server system 14. Client browser 12 is connected to the internet 18 using a local area network 16. The web page can be obtained from corresponding browser caches 10-A, 11-A, 12-A or from the proxy cache 14-B or from the CDN cache 21 and 22 A. The cookies are saved in the cookie data store 10-C, 11-C or 12-C at the browser system.

When a client browser 10, 11 or 12 has to access a web page, first it checks in the browser cache. A browser keeps a copy of cacheable web pages in its local cache and if the content is still valid it uses the local copy. Otherwise, the request is sent to proxy server system 14-A. The proxy server system 14-A checks in its proxy cache 14-B and sends the page from 14-B if it contains a valid copy. If a valid copy of the page could not be found from 14-B, then the request is sent out. The response can be obtained from Content Delivery Network (CDN) 21 or 22 if the web publisher uses the service of the CDN. In case any of these caches does not contain a valid copy of the web page, the request is then served from the origin server 26-A and the event is logged in access log 26-B.

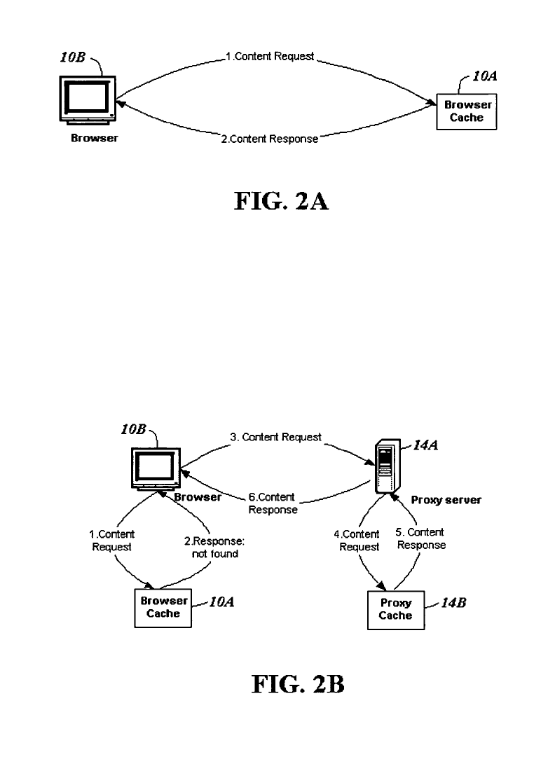

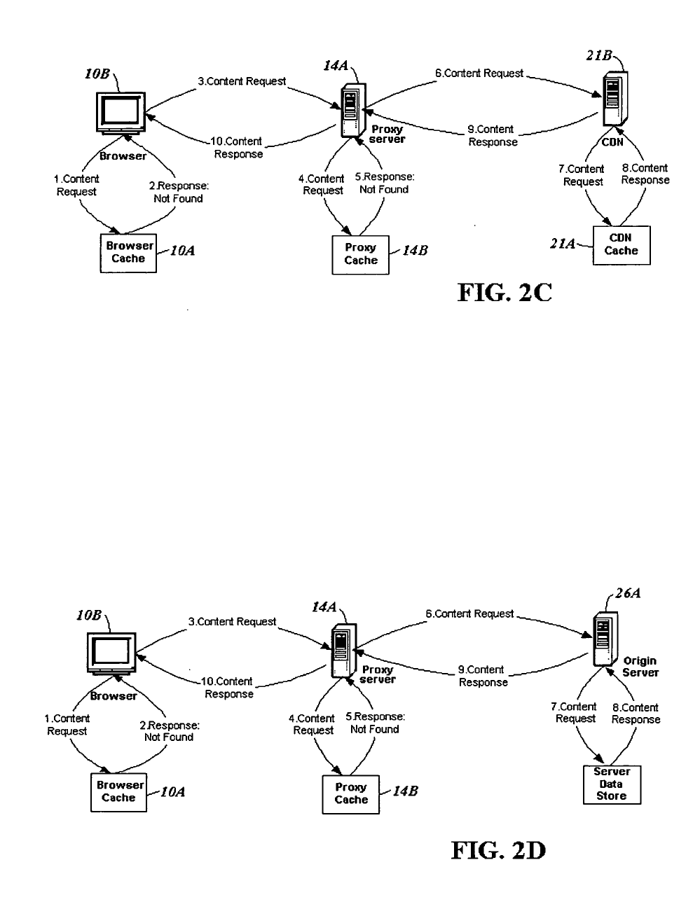

FIGS. 2A-2D provide data flow diagrams illustrating a request and response flow in different cases. In FIGS. 2A-2D, the term “cache-hit” indicates an object is in cache and it is fresh. The term “cache miss” indicates an object is not in cache, or that the object in the cache is stale.

FIG. 2A shows a request served from the browser cache 10A, and a corresponding response from the browser cache 10A provided to the browser 10B occurring after a cache hit. Although FIG. 2A references the browser cache 10A of client browser 10, similar events can occur in other client browsers such as 11, and 12. Reference to client browser 10 is simply made for convenience, as it will be in subsequent figures.

In FIG. 2B the browser 10B sends a request to the proxy server 14A upon a cache miss from browser cache 10A. The proxy server 14A looks in its cache 14B and it is a cache hit. The proxy server 14A then sends the object back to the browser 10B.

In FIG. 2C, the browser 10B sends the request to the proxy server 14A upon a cache miss from browser cache 10A. It is a cache miss in proxy cache 14B. So the proxy server 14A forwards the request to the CDNs. The object is found in the CDN cache 21A. The CDN 21B then sends the object to the browser 10B though the proxy server 14A. Again, CDN system 21 is referenced for convenience, although other CDN systems such as 22 may experience a cache hit.

In FIG. 2D, a request is sent to the origin server (assumed to be web server 26A) after a cache-miss from the browser cache 10A and proxy cache 14B. In some cases the origin server is referenced after a miss from all of the browser cache 10A, proxy cache 14B and each CDN cache. The origin server 26A then serves the object.

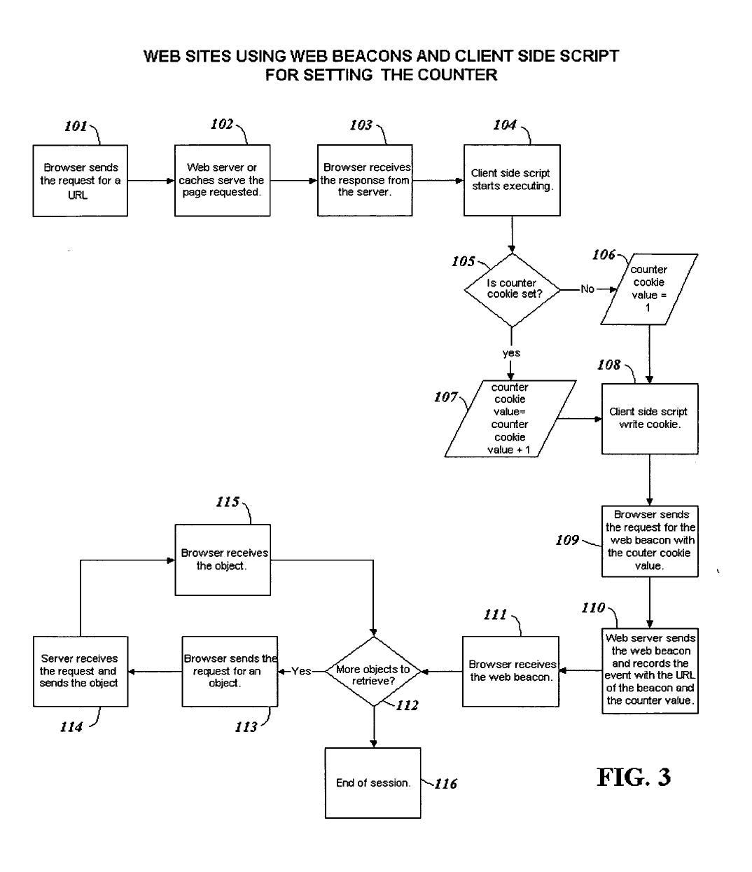

FIG. 3 shows a flow diagram for a process using the components of FIG. 1 for counting unique user visits and counting repeat visits for a cacheable page. The flow diagram of FIG. 3 also uses a web beacon and client side script for setting cookies to assure hits from cache are counted. The process begins with step 101 where a browser sends a request for a web page that has to have user visits accounted for. In step 102, the request is received and served by the origin web server or caches. In step 103 the browser receives a response. In step 104 the client side script in the web page starts executing to count the response.

To provide the count in step 105, the client side script checks whether any counter cookie there has been set for this page. If there are no counter cookies set for this page, then in step 106 a counter cookie is established and its value set to 1. If the counter cookie for this page is established, then in step 107, the counter cookie old value is incremented by ‘1’. In step 108 the Client side script writes the cookie to the cookie data store.

Web beacons are used to assure requests served from caches also get counted. To use the web beacon, in step 109, the browser sends the request for a web beacon with the updated counter cookie for this domain. In step 110, the web server sends the web beacon and then logs the request. The entry contains the URL of the web beacon and the value of the counter cookie. If there is more than one counter cookie for this web page, then there will be one entry each corresponding to the counter cookies of this page in the access-log. In step 111, the browser receives the web beacon. It does not make any difference in the appearances of the web page since it is a 1*1 pixel.

To complete the process in step 112, the browser checks to see whether there are more objects to be retrieved. If there are more objects, in step 113 browser sends a request for an object to be retrieved. In step 114, caches or the origin web server send the response. In step 115, the browser receives object and repeats steps 110 to 115 as long as there are more objects in step 112. When there are no more objects to retrieve, as determined in step 112, the session ends with step 116.

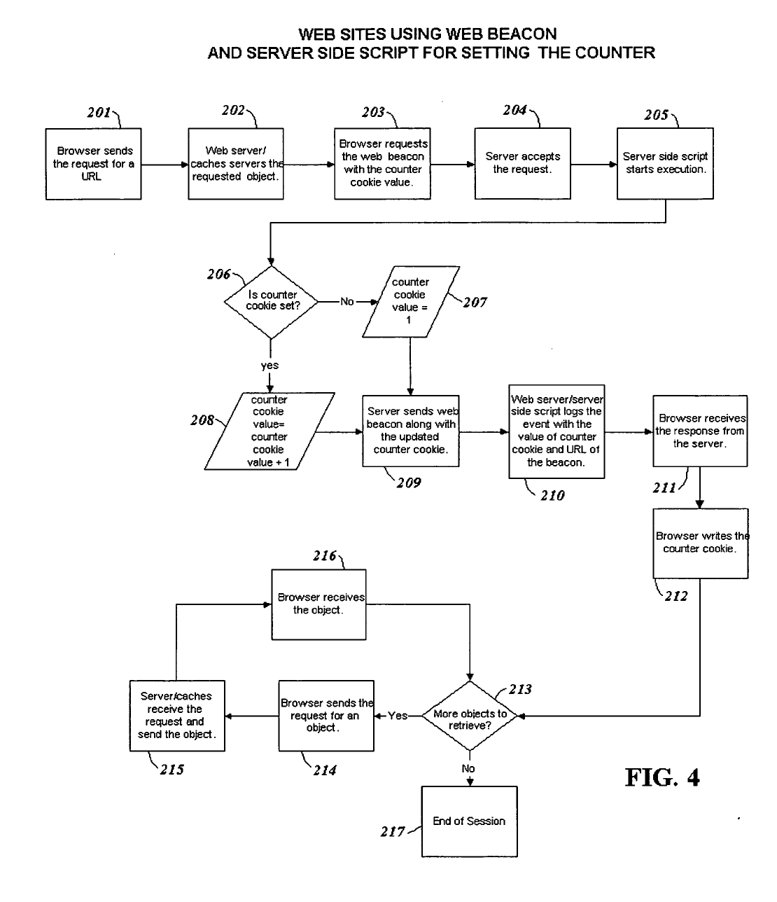

FIG. 4 shows a flow diagram for a process using the components of FIG. 1 for counting unique user visits and counting repeat visits for a cacheable page, as in FIG. 3. The flow diagram of FIG. 4 uses server side script for setting the counter cookies and a web beacon. The process begins with step 201 where a browser sends the request for a URL. In step 202, the web server or the caches serves the page requested. In step 203, the browser sends request for the web beacon specified in the web page retrieved. Before sending the request, the browser checks in the cookie store for the counter cookie for this web beacon and sends the cookies along with the request for the web beacon. In step 204, the server receives the request.

To provide the count in step 205, the server side script starts and in step 206 it checks whether any counter cookie is there with the request. If no counter cookie is there with the request, in step 207 the server side script sets the counter cookie corresponding to this page to ‘1’. If a counter cookie is there with the request, then in step 208 the value of the counter cookie is incremented by ‘1’. In step 209, the web server then logs the event in the access log file. It uses the URL of the web beacon and the value of the counter cookie.

Web beacons are used to assure requests served from caches also get counted. To use the web beacon, in step 209, the server gets the web beacon and sends it with the HTTP header to set the counter cookie value to the modified value. In step 211, the browser receives the web beacon. In step 212 the browser then gets the set-cookie header based on the web beacon and writes the counter cookies to the cookie store.

To complete the process in step 213, the browser checks to see whether more objects are to be retrieved. If another object is there, in step 214 the browser sends a request for the object. In step 215 the server or cache then receives the request and sends the object. In step 216 the client receives the object, and then steps 213 to 216 are repeated until all the objects are retrieved. If no more objects exist, the session ends in step 217.

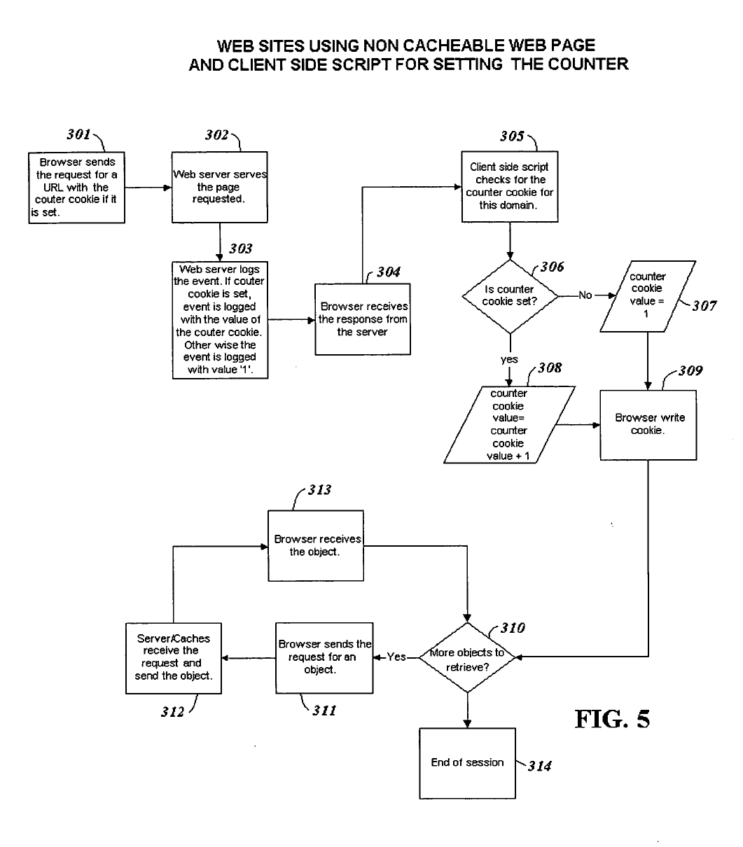

FIG. 5 shows a flow diagram for a process using the components of FIG. 1 for counting unique user visits and counting repeat visits. The flow diagram of FIG. 5 uses client side script for setting the counter cookies, and the web pages are assumed non-cacheable, so a web beacon is not used. The process begins with step 301 where a browser sends the request for a web page. If a counter cookie exists for this site, it is sent with the request. In step 302, the origin web server sends the response. In step 303, the web server gets the counter cookie that was sent by the browser. If no counter cookie was sent by the server, then the counter cookie is set equal to ‘1’ and the event is logged in the access-log. In step 304, the browser receives the response.

To provide the count in step 205, the client side script starts executing and in step 306 it checks for counter cookies set in the system for this web page. If no counter cookies are set, in step 307 the client side script sets the counter cookie with an initial value of ‘1’. If a counter cookie has already been set for this page, then in step 308 the client side script increments the counter cookie value by ‘1’. In step 309, the client side script then writes the cookies to the cookie store.

To complete the process in step 310, the browser checks to see whether more objects are there to download. If more objects are there, in step 312 the browser sends a request for an object. In step 313 the browser then receives the object. Steps 310 to 313 are repeated until all the objects are retrieved. If no more objects exist, the session ends in step 312.

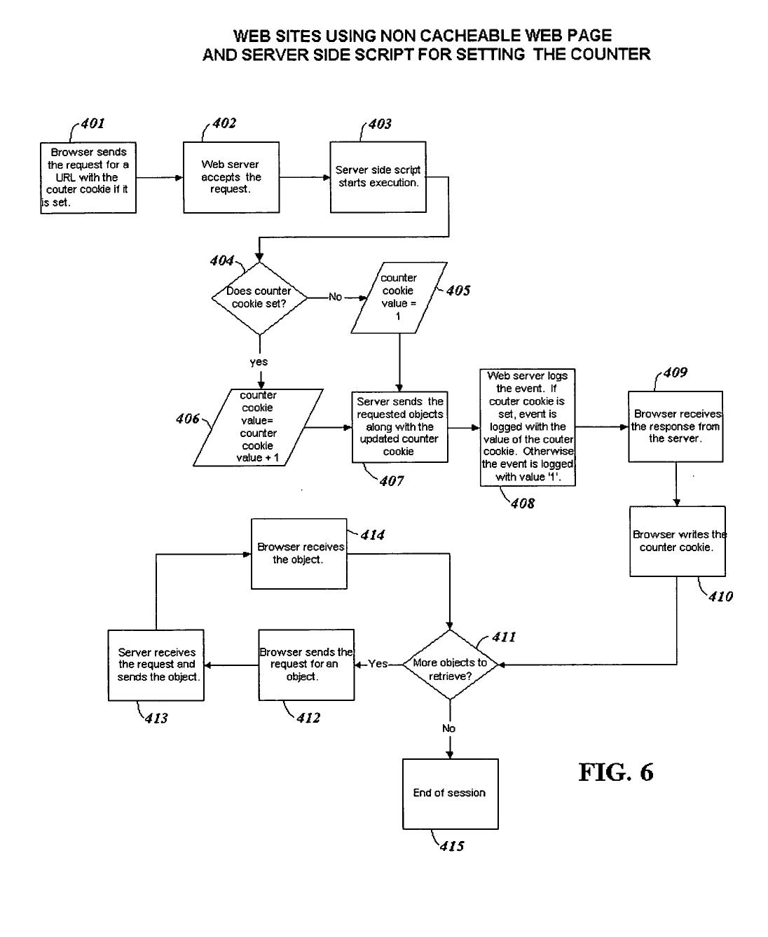

FIG. 6 shows a flow diagram for a process using the components of FIG. 1 for counting unique user visits and counting repeat visits. The flow diagram of FIG. 5 uses server side script for setting the counter cookies, and the web pages are assumed non-cacheable, so a web beacon is not used. The process begins with step 401 where a browser sends the request for a web page. If a counter cookie exists for this site, it is sent with the request, otherwise the request is sent without counter cookies. In step 302, the web server accepts the request from the browser.

To provide the count in step 403, the server side script starts running and in step 404 it checks for counter cookies set in the request. If no counter cookies are set, in step 405 the server side script sets the counter cookie with an initial value of ‘1’. If a counter cookie has already been set for this page, then in step 406 the server side script increments the counter cookie value by ‘1’. In step 407, the server sends the requested object with the header to set the counter cookie to the new value. In step 408, the server logs the event with the value of the counter cookie and URL of the object in the access log. In step 409, the browser receives the object, and in step 410 the browser writes the counter cookies to the cookie data store.

To complete the process in step 411, the browser checks to see whether more objects are there to download. If more objects are there, in step 412 the browser sends a request for an object, and in step 413 the server receives the request and sends the object. In step 414 the browser then receives the object. Steps 411 to 414 are repeated until all the objects are retrieved. If no more objects exist, the session ends in step 415.

FIGS. 7-9 provide data charts showing frequency vs. effective reach taken using a model for the preferred system. FIG. 7 shows a plot of the distribution of effective reach vs. frequency on a weekday. The total number of unique users is 19205. The reach of the ad with a frequency of 2 or more is 15559, i.e. the number of unique users who have accessed the web object at least twice is 15559. The total number of impressions served for this ad is 40658. FIG. 8 shows a plot of the distribution of effective reach vs. frequency on a weekend. The total number of impressions served for this ad is 47556. The reach is 5852 at frequency 4. FIG. 9 is a bar chart showing the weekly distribution of effective reach vs. frequency over a week. The total number of impressions served over the week is 108277.

Although the present invention has been described above with particularity, this was merely to teach one of ordinary skill in the art how to make and use the invention. Many additional modifications will fall within the scope of the invention, as that scope is defined by the following claims.

What is claimed is:

1. A method for calculating reach of a web object using counter cookies.

2. The method of claim 1, wherein at least one frequency of exposure of the web object is calculated using the counter cookies.

3. The method of claim 2, wherein the effective reach of the web object is calculated using the counter cookies.

4. The method of claim 1, wherein the reach comprises the number of users that access the object at least once over a period of time.

5. The method of claim 2, wherein the at least one frequency comprises the number of users that access the object a given number of times over a period of time.

6. The method of claim 3, wherein the effective reach comprises the percentage of users accessing the object at a particular one of the frequencies

7. The method of claim 1, wherein the counter cookies are stored in an access log file with a unique user identification.

8. The method of claims 1 further comprising using access logs associated with the cookies, each access log provided for a different demographic region.

9. The method of claim 1, further comprising using web beacons for counting the events for the object that are accessed from cache.

10. The method of claim 1, wherein a single cookie in the counter cookies is used to count the events for all objects in a domain.

11. The method of claim 1, wherein the counter cookies can be incremented using at least one of client side script and server side script.

12. The method of claim 1, wherein each of the cookies includes a variable pair with a first variable providing a count of accesses and a second variable identifying a web object.

13. The method of claim 12, wherein each cookie is associated with a set of properties.

14. The method of claim 13, wherein the properties comprise at least one in a group consisting of user identification, path, domain name, and expiration time.

15. A method of claim 1, wherein the method is provided for in processor executable form and stored in memory.

16. The method of claim 1, wherein the web object comprises an advertisement.

17. A method for counting user accesses to a web object the method comprising:
identifying an event when a user accesses the web object;
incrementing a counter cookie, the counter cookie comprising a pair of variables including a first variable identifying the web object and a second variable providing the count; and
storing the counter cookie in an access log with a user identification.

18. The method of claim 17, wherein the step of identifying an event when a user access the web object comprises retrieving a web beacon for the web object.

19. A method for determining access to web objects comprising:
establishing a set of events, each event defined by a user, ni and web object oi making up a pair <ni,oi>, where i is an integer;
setting a cookie value when an event occurs, the cookie value providing a count ci of times the cookie has been accessed the object oi; and
storing the cookie value ci and the user ni as a pair <ni,ci> in an access log.

20. The method of claim 19, further comprising:
determining the number of unique visitors of a web object by using the access log to count the number of different ones of the users ni that accessed the object oi.
